(19) United States
(12) Patent Application Publication
(10) Pub. No.: US 2006/0250805 A1
(43) Pub. Date: Nov. 9, 2006

(54) String of decorative pendant lamps for sunblind decoration

(76) Inventor: Hon Kwok Cheng, Hong Kong (HK)

Correspondence Address: RABIN & Berdo, PC, 1101 14TH STREET, NW, SUITE 500, WASHINGTON, DC, 20005, US

(21) Appl. No.: 11/197,647

(22) Filed: Aug. 5, 2005

(30) Foreign Application Priority Data
May 8, 2005 (CN) 200520018102.2

(51) Int. Cl. F21V 21/00

(52) U.S. Cl. 362/391; 362/249; 362/225

(57) ABSTRACT

A string of decorative pendant lamps for sunblind decoration is constructed of a plurality of transparent lamp bodies, each of which, after being electrically coupled with a sub-conductor, is suspended from a main conductor. The main conductor is provided with a plurality of hanging members. The transparent lamp body is formed by a molded part made from acrylic material which a LED is displaced in and integrally secured to by thermal plasticization. The transparent lamp body takes form of stereo multiple curved surfaces which can produce light refraction. In use, the string of decorative pendant lamps for sunblind decoration generates specialized lighting effects, because the LED illumination varies under the control of the lamplight controller, in addition to multiple light-refection, light-transmission natures resulting from the acrylic molded part.

### FIELD OF THE INVENTION

The present invention relates to a lamp ornament for decorating a sunblind.

### BACKGROUND OF THE INVENTION

A wide variety of decorative lightings are currently available, among which the lamp strings simply assembled for decorating front doors of the bars, restaurants and hotels are most commonly used. In some cases, tube lamps are arranged on a roof to give out magic pursuing effects for decorating environments. These decorative lightings are structurally adapted for outdoor decoration. Up to now, there is unavailable in the market for decorative string lamp products suspended from sunblind. People often employ different hanging lamps and projection lamps for interior decoration. This brings about the drawbacks of difficulty in installation, small variation, and lack of stylistic features.

### SUMMARY OF THE INVENTION

It is an object of the present invention to provide a string of decorative pendant lamps for sunblind decoration, which is simple and novel in structure, good in decorative effects and convenient to use.

In order to accomplish the aforesaid object, the string of decorative pendant lamps for sunblind decoration according to the invention is constructed of a plurality of transparent lamp bodies, each of which, after being electrically coupled with a sub-conductor, is suspended from a main conductor.

As another structure of the invention, the main conductor is provided with a plurality of hanging members spaced apart from one another.

As a further structure of the invention, the transparent lamp body is formed by a molded part made from acrylic material which a LED (light-emitting diode) is displaced in and integrally secured to by thermal plasticization.

In a preferred embodiment of the invention, the transparent lamp body takes form of stereo multiple curved surfaces with light refraction.

According to the invention, the string of decorative pendant lamps for sunblind decoration is constructed of a plurality of transparent lamp bodies, each of which is suspended from the main conductor and can transmit and refract light. When used, the string of decorative pendant lamps is suspended from an indoor sunblind in a manner that the pendant transparent lamp bodies generate illumination under control of a lamplight controller so as to produce specialized interior decoration. The string of decorative pendant lamps of the invention is new and convenient to operate.

The invention will now be described in more detail with reference to the accompanying figures.

### BRIEF DESCRIPTION OF THE DRAWINGS

FIG. 1 is a structure of a string of decorative pendant lamps for sunblind decoration of a preferred embodiment according to the invention.

FIG. 2 is a schematic diagram showing a circuit arrangement of the string of decorative pendant lamps for sunblind decoration according to the invention.

### DETAILED DESCRIPTION OF THE INVENTION

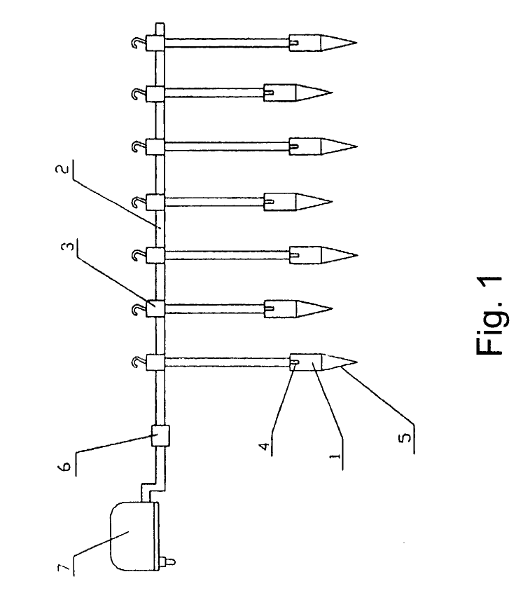

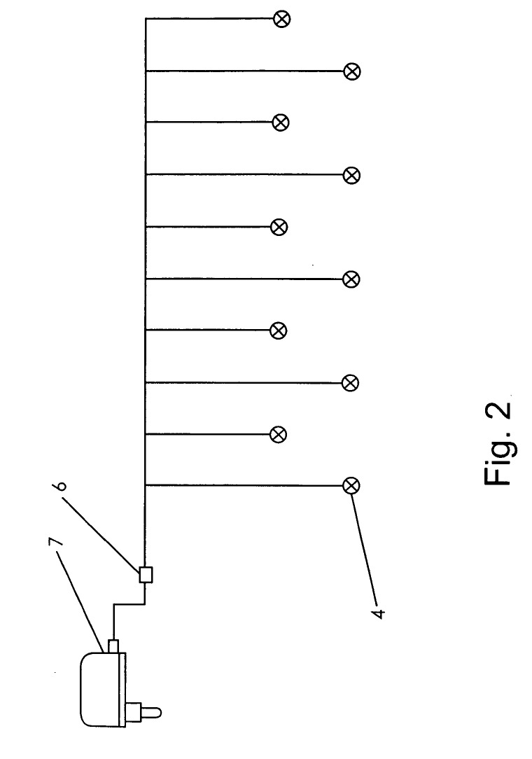

Referring to FIGS. 1 and 2, a string of decorative pendant lamps for sunblind decoration of a preferred embodiment according to the invention is shown in FIG. 1. In this embodiment, the string of decorative pendant lamps for sunblind decoration is constructed of a plurality of transparent lamp bodies 1, each of which, after being electrically coupled with a sub-conductor, is suspended from a main conductor 2. For convenient purposes, the main conductor is provided with a plurality of hanging members 3 spaced apart from one another. The the transparent lamp body 3 is formed by a molded part 5 made from acrylic material which a LED 4 is displaced in and integrally secured to by thermal plasticization. In order to enhance the refraction effects, the transparent lamp body usually takes form of stereo multiple curved surfaces which can produce light refraction. When used, the main conductor 2, connected to the transparent lamp bodies 1, is electrically coupled with a lamplight controller 7 via a power supply switch 6 so that the transparent lamp bodies are under control of the controller 7 to generate illumination. A conventional string lamp controller may be used as the lamplight controller 7.

Different coloured LEDs may be employed to be displaced in the transparent lamp bodies 1 to give out different decorative effects.

According to the invention, the number of the transparent lamp bodies generally ranges between 5 and 10.

In use, the string of decorative pendant lamps according to the invention generates specialized lighting effects, because the LED illumination varies under the control of the lamplight controller, in addition to multiple light-refection, light-transmission natures resulting from the acrylic lamp bodies.

The string of decorative pendant lamps for sunblind decoration according to the invention features easy operation and variation in product category.

Numerous variations and modifications are easily obtainable by means of the skilled person's common knowledge without departing from the scope of the invention, for example, the transparent lamp body may be easily changed in its shape and color. However, such variations and modifications should fall into the scope of this invention.

What is claimed is:

1. A string of decorative pendant lamps for sunblind decoration, characterized in that it is constructed of a plurality of transparent lamp bodies, each of which, after being electrically coupled with a sub-conductor, is suspended from a main conductor.

2. A string of decorative pendant lamps for sunblind decoration as claimed in claim 1, characterized in that the main conductor is provided with a plurality of hanging members spaced apart from one another.

3. A string of decorative pendant lamps for sunblind decoration as claimed in claim 1 characterized in that the transparent lamp body is formed by a molded part made from acrylic material which a LED is displaced in and integrally secured to by thermal plasticization.

4. A string of decorative pendant lamps for sunblind decoration as claimed in claim 3, characterized in that the transparent lamp body takes form of stereo multiple curved surfaces with light refraction.

5. A string of decorative pendant lamps for sunblind decoration as claimed in claim 1, characterized in that the transparent lamp body takes form of stereo multiple curved surfaces with light refraction.

6. A string of decorative pendant lamps for sunblind decoration as claimed in claim 1, characterized in that the main conductor connected to the transparent lamp bodies is electrically coupled with a lamplight controller via a power supply switch.

7. A string of decorative pendant lamps for sunblind decoration as claimed in claim 2, characterized in that the transparent lamp body is formed by a molded part made from acrylic material which a LED is displaced in and integrally secured to by thermal plasticization.

8. A string of decorative pendant lamps for sunblind decoration as claimed in claim 7, characterized in that the transparent lamp body takes form of stereo multiple curved surfaces with light refraction.

9. A string of decorative pendant lamps for sunblind decoration as claimed in claim 2, characterized in that the transparent lamp body takes form of stereo multiple curved surfaces with light refraction.
